(19) United States
(12) Patent Application Publication
(10) Pub. No.: US 2014/0278449 A1
(43) Pub. Date: Sep. 18, 2014

(54) METHOD AND APPARATUS FOR GUIDING PATIENTS TOWARD HEALTHCARE GOALS

(71) Applicant: ZOCDOC, INC., New York, NY (US)

(72) Inventor: Oliver D. Kharraz Tavakol, Brooklyn, NY (US)

(73) Assignee: ZocDoc, Inc., New York, NY (US)

(21) Appl. No.: 13/796,417

(22) Filed: Mar. 12, 2013

(51) Int. Cl. G06F 19/00

(52) U.S. Cl. CPC G06F 19/345
USPC 705/2

(57) ABSTRACT

System and method for guiding patients toward completion of recommended healthcare actions based on the individual patient's profile, as well as incorporating aggregate patient population data (e.g., generally accepted or current best practices) in one or more healthcare fields for driving the recommendations to the patient population most likely to benefit from such practices. In addition, the system/method allows different providers (e.g., healthcare providers, insurance providers, and other providers) to establish their own rules for their own subsets of patients. The system/method may include monitoring and tracking patient completion of the recommended actions.

### FIELD OF THE INVENTION

The present invention relates to a method and apparatus for assisting patients in determining and meeting healthcare goals.

### BACKGROUND

With ongoing rising costs and policy changes associated with healthcare management, it is expected that more responsibility will shift to the individual consumer (patient) to monitor and manage his own healthcare and the services associated therewith. Unfortunately, the average consumer of healthcare services does not have the knowledge base to determine what actions might be taken to improve his current health and avoid future health problems. Often, he has no or limited access to his personal medical records, e.g., he must initiate a request to each of his healthcare providers and await receipt of copies. Even then, the data in the records quickly becomes outdated and may not be easily stored or searchable. Nor does the average consumer have the knowledge to determine, understand or objectively consider what are the current best practices in each medical field, and how they apply to him. The overwhelming volume and rate of change of medical research, clinical studies and even dietary advice, leaves the ordinary consumer unable to effectively navigate the available information and assume responsibility for his own healthcare. Still further, the places where this information is usually presented (e.g., newsletters or journal articles) provide no mechanism for taking any action, thus leading to short-lived intentions that are not put into practice, and therefore don't have the intended impact.

### SUMMARY OF THE INVENTION

In accordance with an embodiment of the present invention, there is provided a computer-implemented method and apparatus for applying rules (process logic) and rules data to drive healthcare recommendations to consumers (also referred to as patients). The method allows providers of such rules and recommendations to monitor the consumer responses and further enables each consumer to manage and track his own healthcare actions. In addition (or alternatively) a system and method are provided for delivering recommended healthcare actions that enable the recipient to immediately take action in accordance with the recommendation.

The system removes the burden from the patient in having to independently determine what actions may be most suitable (e.g., recommended by medical authorities) for his particular patient profile. It also provides a tool by which the patient can easily implement the recommended action and maintain a record of what actions have been taken.

In one embodiment, the system includes a rules engine which produces recommended action items for various subsets of a patient population based on each individual patient profile, as well as incorporating what may be considered generally accepted or current best practices in one or more healthcare fields for driving the recommendations to the patient population most likely to benefit from such practices. In addition, the system allows healthcare specialists, including healthcare providers, insurance providers, employee benefit plans, and other sources of healthcare advice or services (aggregators) to establish their own rules for their own subsets of patients, which customized rules may override the general rules.

These and other features of the present invention will be apparent from the following detailed description of certain preferred embodiments, which are described in conjunction with the accompanying drawings.

In accordance with one embodiment of the invention, a computer-implemented method is provided comprising:
storing electronic patient data for a plurality of patients in a data storage unit;
analyzing in a computer the patient data by applying process logic to the patient data of a particular patient to generate one or more recommended healthcare actions for the patient;
generating by a computer and transmitting to the patient an electronic message including the recommended actions;
wherein the process logic is based on one or more of:
best medical practices;
evidence based rules;
clinical rules;
healthcare provider preferences;
policies and payor rules;
financial coverage;
consumer preferences; and
aggregate population clinical data.

In one embodiment, the process logic filters based on one or more of patient specific filters, healthcare provider specific filters, patient's eligibility for insured healthcare services or benefits, healthcare spending accounts, and employer-operated benefit services associated with the recommended actions.

In one embodiment, the actions include one or more of: becoming informed about the nature of a healthcare issue;
consulting a healthcare provider to evaluate a health issue; and
providing an interactive user interface for the patient to monitor his/her healthcare.

In one embodiment, the message comprises one or more of email, text, mobile application, webpage or other electronic messaging system.

In one embodiment, the message includes an interactive link through which the patient selects or implements one or more of the recommended actions.

In one embodiment the message includes as a recommended action booking an appointment for healthcare provider services and the message includes a link for implementing the recommended action.

In one embodiment the method further includes:
electronically tracking the patient responses to the recommended actions.

In one embodiment the tracking comprises monitoring healthcare provider appointments of the patients.

In one embodiment, the patient data includes one or more of check-in data, medical history, family history, demographic, symptom, insurance, clinical, health, wellness, preventive medicine, medication, and mental health.

In accordance with one embodiment of the invention, a computer-implemented method is provided comprising:
for a collection of stored patient profile information for a plurality of patients and a collection of tags, each tag comprising a recommended action for one or more patients;
for each tag of the collection, applying application logic that determines if a tag of the collection is applicable to a respective patient based on the patient's stored patient profile information and for one or more of the determined applicable tags;
transmitting a message to the respective patient concerning the applicable tags, the message including an interface for implementing the recommended actions;
following the transmitting, monitoring the respective patient for completion of recommended actions of the associated tags.

In one embodiment the application logic includes determining if the recommended action has not been fulfilled for the respective patient and transmitting messages for one or more tags that are both applicable and not fulfilled.

In one embodiment the tags comprise one or more best practices for patient care.

In one embodiment, the tags comprise one or more of scheduling a healthcare appointment and supplying patient information.

In one embodiment the method applying includes segment logic that selects among different variants of a message for an associated tag based on the patient profile information for the respective patient and the method includes comparing the patient completion for the different message variants.

In one embodiment, one or more of the application logic and

segment logic filters based on one or more of the healthcare provider and insurance provider of the respective patient.

In accordance with one embodiment of the invention, a computer-implemented method is provided comprising:
collecting electronic rules data from multiple healthcare or insurance providers, the data including recommended healthcare actions based on patient parameters;
generating by a computer relative priority values for the collected rules data and storing the collected rules data and priority values in a data storage unit;
on a periodic basis, applying process logic and the stored rules data and priority values to individual electronic patient profile information for a plurality of patients to:
   identify a match of individual patient to the rules data based on the associated patient parameters and patient profile information;
   selecting by the computer one or more of the matches based on the priority values of the associated rules data; and
   generating by the computer, an electronic message including one or more recommended healthcare actions based on the selected matches.

In one embodiment, the method further comprises: electronically tracking the patient responses to the recommended actions.

In one embodiment, the method further includes: comparing the tracking responses of multiple patients.

In one embodiment, the message includes an interactive link through which the patient selects or implements the recommended action.

In accordance with one embodiment of the invention, a data processing system for recommending patient healthcare actions is provided, the system comprising:
a communications controller,
a data storage unit having stored therein:
   patient profile information for a plurality of patients;
   a plurality of tags, each tag comprising a recommendation for patient healthcare action and rules, the rules including rules determining whether a recommendation for a patient is applicable and unfulfilled;
a computer, coupled to said data storage and to said communications controller to:
   for a patient, apply a set of one or more tags to the patient profile information,
   for an applied tag that is applicable and unfulfilled, generate an electronic message for the patient with the recommended healthcare action,
   transmit the electronic message to the patient via the controller.

In one embodiment, the stored data further includes a limit on the number of tags sent to a patient over a given time period, and the controller transmits no more than the designated number of electronic messages to the patient in the designated time period.

In one embodiment, the data storage unit includes different tag sets for different rules providers, the different rules providers comprising healthcare providers, insurance providers, and other rule providers associated with a patient, and wherein the patient profile information includes an identification of the patient's associated providers, and the computer is configured to select from the tag sets of the associated providers for the patient.

In one embodiment, the stored data includes a priority for each rules provider and the computer is configured to apply the rules provider priority in determining a priority in which to transmit electronic messages to the patient.

In one embodiment, the stored data includes a tag priority and the computer is configured to apply the tag priority in determining an order and limit for transmitting electronic messages to the patient.

In one embodiment, the computer is further configured to track patient responses to the recommended actions.

In one embodiment, the computer is configured to compare the track responses.

### BRIEF DESCRIPTION OF THE DRAWINGS

FIGS. 1A and 1B are flow charts illustrating two embodiments of the invention, FIG. 1A illustrating a method of determining recommended healthcare actions for transmission to patients, and FIG. 1B illustrating another embodiment for selecting one or more variants of a message for a select segment of a patient population and monitoring the patient actions;

FIG. 2 is a schematic illustration of a network for gathering patient data and healthcare data from various sources;

FIG. 3 illustrates one embodiment of an apparatus for implementing the invention, including an aggregator server that communicates with a patient database and an healthcare action database;

FIG. 4 is a schematic illustration of one embodiment of a communications system enabling an aggregator to communicate over a network with a plurality of patients, healthcare providers and insurance providers;

FIG. 5 illustrates a database schema for implementing one embodiment of the invention, utilizing tag, segment, provider and message data structures;

FIG. 6 (two sheets 6A and 6B) illustrates a more extensive database schema utilizing the data structures of FIG. 5 according to one embodiment of the invention, which allows different providers to provide different rule sets for determining recommended healthcare actions and messages;

FIG. 7 illustrates one example of a message sent to a patient with recommended healthcare actions;

FIG. 8 illustrates a patient dashboard according to one embodiment of the invention for viewing and responding to recommended healthcare actions;

FIGS. 9-11 are flowcharts illustrating different embodiments of the invention for generating a list of applicable tags for a patient (FIG. 9, two sheets 9A and 9B), amending the list of applicable tags to outstanding tags (FIG. 10, two sheets 10A and 10B), generating messages from the resulting tag list and tracking patient completion of such tag messages (FIG. 10), and an alternative embodiment of marking tags as outstanding or completed, tracking patient completion, and sending the marked tags to a patient for viewing on a patient display (FIG. 11, two sheets 11A and 11B);

FIG. 12 is a schematic diagram of a system configuration for communications between one or more of an aggregator, patients, and practice and/or insurance groups;

FIG. 13 is a schematic diagram illustrating a data staging area for compiling healthcare information from a plurality of healthcare information sources.

### DETAILED DESCRIPTION

Various embodiments of the present invention are now described with reference to the drawings. In the following description, for purposes of explanation, numerous specific details are set forth in order to provide a thorough understanding of one or more implementations of the present invention. It will be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The present invention may also be illustrated as a flow chart of a process of the invention. While, for the purposes of simplicity of explanation, the one or more methodologies shown in the form of a flow chart are described as a series of acts, it is to be understood and appreciated that the present invention is not limited by the order of acts, as some acts may, in accordance with the present invention, occur in a different order and/or concurrent with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

In various embodiments of the invention disclosed herein, the term “physician”, “doctor” or “provider” is used to identify a physician or other healthcare provider administering patient care, as well as members of his/her staff that assist in providing such care or are responsible for maintaining the provider's scheduling calendar and/or patient records.

Further, a “practice group” or “provider group” may be any entity linking a group of providers through shared facilities, services or referral agreements. This may include, but should not be limited to, integrated multi-facility hospitals, insurance networks, medical groups and multi-doctor practices.

As used herein “patient” means an existing patient, or a prospective (potential new) patient, of a healthcare provider, physician or practice group. In the context of the present invention, an aggregator (defined below) is also considered a healthcare provider having patients (consumers of the aggregator services).

In one or more embodiments of the invention described herein, an “aggregator” is a centralized service provider that provides a wired or wireless network-based service to patients and to one or more practice groups (e.g., physician groups, hospitals, clinics) and/or insurance providers. For example, an aggregator server may provide an application or web-based data processing service and interface to a computer, server, or other wired or wireless communication device (e.g., cell phone, tablet computer, etc.) of one or more patients, practice groups, healthcare providers, and/or insurance providers.

FIG. 1A illustrates one method embodiment for determining recommended healthcare actions 13. The method 10 includes generating and transmitting to patient(s) message(s) regarding the recommended healthcare action(s) 14, and monitoring (tracking) the patient(s) actions relating to the recommended healthcare action(s) 15. For example, the recommended action may be to schedule a particular type of appointment, and the message may include a link to enable immediate (real-time) scheduling of an appointment. This method may be implemented by the system 30 illustrated in FIG. 3, wherein an aggregator server 31 includes a recommendation module 32, a tracking module 33, and a scheduling module 34. A patient database 35 and an action database 36 communicate with the modules of server 31 as described further below.

Returning to FIG. 1A, a determination of recommended healthcare actions is made by a rules engine that processes logic and rules data for determining appropriate recommended healthcare actions for select patients. The rules engine 13 receives patient profile data 11 (e.g., from patient database 35), which may include, for example, for each individual patient, his medical history, demographics, family information, insurance information, patient contact information, and healthcare provider information. The rules applied by the rules engine are based on more generally applicable healthcare data 12 (e.g., best practices) applicable to different groups of patients having different medical conditions or other attributes. For example, FIG. 2 illustrates various sources 20 of healthcare data 12, including clinical studies 28, healthcare benefits information records 27, healthcare knowledge base 26, and best practices 25. In this example, the individual patient data 11 may be provided by the patient himself 24, and/or by his healthcare provider, in the form of records 23 and/or insurance provider records 22. The current method utilizes both types of data 11, 12 to determine a recommended healthcare action for a patient or a group of patients.

As illustrated in FIG. 1A, an aggregator may compile from various entities healthcare data from which to formulate the recommendation rules. Representative sources may be, for example:
Centers for Disease and Control Prevention;
American Academy of Dermatology;
Academy of Nutrition and Dietetics;
National Institutes of Health;
State Departments of Health; and
State Boards of Medicine.

As described in more detail below, the recommendation module 32 implements the rules logic and data stored in the healthcare action database 36 for making recommendations. One example of a database schema for such an action database is illustrated in FIGS. 5-6, as described below. The rules engine contains application logic that determines whether a recommendation is applicable to a particular patient (or patients), and may also select the message for a particular action, e.g., according to different rules and message sets customized by/for different providers. The messages are distributed and the responses of the patients monitored and optionally compared over time to determine which messages are more effective in producing a recommended action (inducing or nudging the patient to take such action). Such monitoring or tracking may be accomplished by the tracking module 33 illustrated in FIG. 3. One example of a desired action is to encourage the patient to schedule a healthcare appointment, which scheduling may be accomplished by the scheduling module 34 of FIG. 3.

FIG. 4 illustrates a communications system 40 enabling an aggregator 42 to communicate over a network 41 with each of a plurality of patients 43, healthcare providers 44, and insurance providers 45, according to the present invention. For example, the aggregator may both collect patient data from one or more of the patients 43, healthcare providers 44, and insurance providers 45, for populating the patient database 35. In addition, the aggregator may communicate with the patients 43, healthcare providers 44, and insurance providers 45, to track the patient responses to the recommended actions. Still further, the aggregator 42 may communicate with patients 43, healthcare providers 44, and insurance providers 45, in order to enable patient(s) to take the desired action(s), such as scheduling a healthcare appointment with a provider or providing desired patient information for a patient profile maintained by the aggregator 42, healthcare provider 44 and/or insurance provider 45. Still further, the aggregator 42 may receive from the healthcare providers 44 and insurance providers 45 data for formulating custom rules and recommendations for the respective patient populations of the providers, which custom rules and recommendations would then take precedence (override) the more general rules and recommendations of the aggregator.

FIG. 1B illustrates yet another method embodiment of the invention, which includes feedback loop(s) for optimizing 110 recommendations. Here, an aggregator receives clinical patient (individual profile) data 111, such as check-in data and/or medical records, directly from the patient and/or from a healthcare provider and/or from an insurance provider. The aggregator also receives aggregate population clinical data 112, which it uses to determine (formulate) a set of rules for making recommended healthcare actions 113. The rules include selecting a segment of the patient population 114 to which a particular action may be applicable based on patient attributes (from data 111). It further includes selecting from among one or more variants of a message for the selected patient segment 115, whereby different patients within the same segment may receive different variants of a message, all related to the same healthcare action, for testing the effectiveness of the different message variants. The messages are transmitted to the patients 116 and the aggregator then monitors the patient actions relating to the recommended healthcare actions 117. Based on such monitoring, the aggregator may feed back instructions to step 113 to modify future determinations of recommended healthcare actions, for example, by modifying the rules and/or data that is utilized in formulating those rules. In addition, the aggregator may modify or update the clinical patient data 111 (by feeding back updated or modified data) so that the patient, healthcare provider and/or insurance provider can learn what action(s) have been taken by the patient.

FIG. 5 illustrates a particular database schema for implementing one embodiment of the invention. The schema uses the following data structures:
Tag: A tag is a recommendation to take an action. An example of an action is “See a primary physician for your annual physical”. The tag contains logic that determines whether the recommendation is applicable to the patient (e.g., patients over 40 need aspirin counseling), and whether the recommendation has been fulfilled (e.g., patient John Smith has already been counseled for aspirin).
Segment: Segments are a way to split populations of patients associated with a tag, and deliver the message that is most relevant for that group. A tag can have many segments. E.g., of the patients recommended to get a skin screening, men are sent a message with a different message content than women.
Provider: Different providers, e.g., healthcare providers, insurance providers and other types of providers (sources of healthcare information, appointment booking, healthcare advice), can each provide their own custom rule sets (tags) for their associated patients (consumers). E.g., the rule selects (filters) based on a different threshold or patient parameter and/or generates a different message content or method of delivery.

One example utilizing such data structures is set forth below:
Tag: Annual Physical
Segment: Female patients
Message: Booking a check-up is as easy as 1, 2 (Who needs 3?)

The processing logic for determining recommended actions may include one or more filters, including patient specific filters, provider specific filters, and financial filters.

An example of a patient specific filter is an “annual physical” tag that is applicable to patients 18 and older. It is unfulfilled if a patient has not had an annual physical appointment within the last year. The segment logic is determined based on patient gender.

As an example of a provider specific filter, the aggregator can implement custom rules and recommendations (custom tags) for a patient population of a specific healthcare provider, insurance provider, or employee benefit plan. These custom rules will then override the aggregator's general rules and recommendations (general tags).

As an example of a financial filter, the aggregator can implement custom rules and recommendations (custom tags) for a particular benefit care provider. For example, an employer may cover its employees for the Hepatitis B vaccine, and want to encourage all of its employees to get this shot (recommended action). The aggregator can then select patients (employees) of this employer to receive a message recommending the Hepatitis B vaccine. In various embodiments, this recommendation may be sent to the employees (patients) in addition to the other recommendations of the aggregator or instead of the aggregator's recommendation, for example, by giving a higher priority to the recommendations of the specific rule provider for its affiliated patients.

FIG. 7 illustrates one example of a message 190 providing a recommended healthcare action. In this example, the aggregator (ZocDoc) sends the patient a message, e.g., via email, sms, mobile application or via a website (e.g., a patient accesses his home page on the aggregator's website), setting forth the recommended healthcare action. Here, the message includes a plurality of recommended actions. A first recommended action 191 is to book an annual physical now for which the aggregator provides a link 194 (Click here) to enable completion of the recommended healthcare action. In this example, the aggregator provides a scheduling service whereby a patient can immediately (in real-time) book an appointment, either with a doctor for whom the patient has an existing patient-doctor relationship or with a new provider for which there is no pre-existing relationship.

The next item on the list is a recommendation 192 that adults get a blood pressure screening, and references the source of that recommendation (the US Preventive Services Task Force). The message also recommends 192 a flu vaccine (according to the Center for Disease Control CDC). The message concludes with a recommendation 193 that the patient discuss these recommendations with a doctor by booking an appointment immediately (in real time) via the link (button 195) provided in the message.

In one embodiment, the aggregator provides the patient with a tool for managing his medical history. For example, the aggregator may provide an Internet-enabled application, accessible to the patient, for monitoring prior actions taken and outstanding actions (not yet fulfilled). FIG. 8 illustrates a patient home page (dashboard) 140 on an aggregator's website that provides a graphical user interface listing past and future healthcare appointments with an identification of the healthcare providers, and a list of recommendations for this patient. The recommendations 141 may include a list of all tags the patient is eligible for. It may also include the outstanding tags (requiring action) that are displayed differently than tags that have already been fulfilled, e.g., completed action “Vision Exam” has a highlighted check mark, while uncompleted action “Dental Cleaning” does not. With this display, the patient can monitor his own history of compliance and easily be notified and reminded of new recommendations. The interface may further provide an interactive component enabling the patient to implement the recommendation, such as a button (Book Now 142) for scheduling an appointment (e.g., via the aggregator website) and/or a window for entering patient information desired by one or more of a healthcare provider, insurance provider, or the aggregator, and enabling transmission of that message to the respective party (e.g., by clicking on a transmit button). The interface may also enable, for example, scheduling of an appointment with a suitable provider, either one of the patient's existing providers or enabling selection of a new provider having near term available appointments in a convenient geographical location.

The database schema 50 of FIG. 5 will now be discussed in greater detail.

A first table 51 labeled TagConfig includes the following fields or columns. A first column 52 contains the TagConfigId, and the next column 53 contains a Name (description) of the recommended action, e.g., 6 month dental check-up. Columns 54-55 (ValidFrom, ValidTo) are optional and can be used for recommended actions that are best implemented within a particular time period, e.g., a seasonal recommendation to obtain a flu shot.

The Status column 56 may be used for record keeping, and is not relevant here. Columns 57 and 58 contain the rules, stored in a stream text field, by which the rules engine evaluates and determines the applicability 57 of a tag to a particular patient (i.e., true or false). The ExpressionOutstanding rule 58 determines what tags are outstanding for a particular patient, i.e., have not been responded to or performed. This allows the rules provider, e.g., aggregator, healthcare provider, and/or insurance provider, to monitor what actions remain outstanding.

The next column 59, ProcedureId, is a key to the type of action (recommendation) that should be taken, e.g., the type of appointment that should be booked with a particular provider to satisfy the recommended action. The final columns 60, OriginalTagId, allows a rules provider to customize an existing tag (discussed further below).

A second table 61 labeled TagSegmentConfig includes a first column 62 containing the TagSegmentConfig Id. The next column 63, TagId, is a link to the tag (TagConfig table 51). Column 64, Name, is a description of the tag segment; for example, the segment may refer to males, with females being a different segment. The next column 65 (Status) is not relevant here. The next column 66, ExpressionIsMatch, contains the rule for evaluating whether there is a match between the patient and Tag; for example, if the patient is male, he is placed in this Segment.

The next column 67, Priority, determines what action is taken if a patient has matches for two TagSegments, determining which Segment to select. For example, the patient may be male and over 45 years of age. These two attributes may trigger two separate Segments. The logic selects the Segment with the higher Priority. In another example, if the patient's doctor has a customized rule regarding this tag, then the doctor's tag is given a higher priority so that doctor's message is selected for this patient segment.

A third table 71, labeled RulesProvider, includes a first column 72 with the RulesProviderId. The second column 73, Name, is a description of the specific rules provider (e.g., healthcare provider or insurance provider) having its own rule set to be applied to its associated patients. The next column 74, ExpressionIsMatch, is the rule for determining whether a patient is associated with the specified rules provider. The last column 75, Priority, contains a value that is used to determine the relative priority of a RulesProvider for a patient associated with multiple providers, each having its own applicable rule sets.

A fourth table 91, labeled RulesProviderTag, includes a first column 92 with the RulesProviderId as a link to the RulesProvider table 71. The next column 93 contains the TagConfigId, a link to the TagCongId table 51. The third column 94 contains a tag priority, namely a value that determines a relevant ranking of the tags of that particular provider. This may be used when creating a list of ordered tags for a specific patient of that provider, where multiple tags may be applicable and unfulfilled, and where there is a limit of the number of such applicable and unfulfilled tag messages sent to a patient over a given time period. In such case, the one or more message(s) (within the limit) for that patient will be sent in the order determined by the tag priority. For example, the RuleProvider may limit the number of messages sent to any one patient to one per month, so as to avoid being perceived as spam or otherwise annoying the receipt (patient).

The fourth table 81, labeled TagEmailMessagingHistory, includes a first column 82 with the ID. A second column 83, PatientId, identifies the patient to whom an email message (for the associated tag) is sent on given day. The next column 84 is a link to the TagSegmentConfig table 71. The next column 85, DateCreated, contains the date the email message was created and transmitted to the patient. The next column 86, MessageId, is a link to an EmailMessage table (shown in FIG. 6) identifying a particular email message; alternatively, the message communication medium may be text, SMS or any other electronic medium. The last column, RulesProviderId, is a link to the RulesProvider table 71, i.e., the source of the tag/message.

The database schema illustrated in FIG. 5 may be implemented on a daily basis as follows. First a process logic pulls for each patient from a patient database (see 125 in FIG. 7) a data structure of patient profile information that the formulas (rules) can run against (see the following example data structure used in tag rules). The process (e.g., rules engine) then processes each patient (in order) and sequences through a list of tags as determined by the associated rules provider(s) for this patient, to create matches between patient and tag (rule 57) and for actions unfulfilled (rule 58). From this set of patient/tag matches, for each patient the rules engine selects one (or more) tag(s) based on the rules provider and/or tag priority (e.g., 67, 94, and/or 75), and any other limits (e.g., as to the number of messages and/or amount of time) since the aggregator last sent this patient a message. For example, if an aggregator decides to send this patient only one message per month, and that limit is already reached, then the matched patient/tag may be excluded (deleted) from the set of matches. Assuming the limit has not yet been reached, the tag segment with the highest priority will be selected. As previously discussed, this priority may be based on the patient's own healthcare provider, insurance provider, and/or employer having specified its own message variants to be used with patients in its specific patient population (e.g, source of custom rules identified in tables 71, 91).

In order to encode a new rule (e.g., best practice) into the database schema of FIG. 5, the following actions are taken:
add a columns to the TagConfig table 51;
write code (formulate a rule) to determine which patients will receive this tag (ExpressionApplicable 57 and ExpressionOutstanding 58);
create tag segments (table 61) (or RulesProvider and RulesProviderTag tables 71, 91 if there are custom rules for a particular provider); and
create a message template for each segment (table 122).

This database schema will easily scale and allows for the generation of new rule sets for many different sources of healthcare recommendations, patient populations, healthcare providers and/or insurance providers.

Other examples of a tag, tag segment, and data structure used in tag rules, are set forth below:

### Example of Tag:

### Name: OBGYN Annual Visit

### ExpressionApplicable: Patient.Age>21 && Patient.Sex==“Female”

### ExpressionOutstanding: Patient.Appointment.Procedure(“Annual OBGYN”).Booked

### Days Ago>360

### Example of Tag Segment:

Name: Patients under 30

### ExpressionIsMatch: Patient.Age<30

Example of data structure used in tag formulas (rules):

### Patient

Sex
Age
AddressInfo
InsurancePlan[ ]
   Id
   Name
   Type
Appointment[ ]
   Specialty
   Procedure
   DoctorId
   BookedDaysAgo
   HappenedDaysAgo
Medical History[ ]
   QuestionId
   QuestionText
   AnswerId
   AnswerText

FIG. 6 illustrates one embodiment of linking the five database tables illustrated in FIG. 5 to additional tables for purposes of transmitting messages to the patient and/or for communicating patient information and responsive actions (e.g., for monitoring the response rate or effectiveness of the different messages). The table relationships are apparent from the links illustrated in FIG. 6 and will be described briefly below.

Table 121 labeled “Email Message” links to the TagEmailMessagingHistory table 81, and also links to Patient table 125 and MessageTemplate table 122, to facilitate transmission of the desired message variant in an email to a respective patient. The MessageTemplate provides the content (MessageBody) of the message and is linked to the TagSegmentConfig table 61 which determines a match between a patient and tag.

Patient table 125 links to each of an AppointmentHistory table 127, PatientInsurance table 128, CheckInMedicalHistory table 126, as well as EmailMessage table 121 and TagEmailMessagingHistory table 81. The Patient table includes a PatientId and identifies the patient by for example name, date of birth and email address. The PatientInsurance table 128 links to InsurancePlan table 129, which in turn links to Insurance Carrier 130, collectively describing (determining) the insurance attributes for the patient. The AppointmentHistory table 127 links to both the Patient table 125 and InsurancePlan table 129, and identifies, for example, the healthcare provider(s) with whom the patient has prior or future appointments and the relevant insurance information.

The CheckInMedicalHistory attributes provided in table 126 are a convenient mechanism for obtaining relevant patient profile information, e.g., patient data 11, 111 of FIGS. 1A, 1B. In one embodiment, the aggregator prompts the patient to submit and update relevant check-in patient information and the aggregator then stores this data for access by one or more of the patient, healthcare providers and/or insurance providers designated by the patient. This provides a convenient mechanism for the healthcare and insurance providers to update their records and avoid repeated requests to the patient for such information at the beginning of each healthcare appointment.

FIGS. 9-11 describe different embodiments of the invention for generating a list of applicable tags for a patient (FIG. 9), amending the list of applicable tags to outstanding tags (FIG. 10), generating messages from the resulting tag list and optionally tracking patient completion of such tag messages (FIG. 10), and an alternative method of marking tags as outstanding or completed, tracking patient completion, and sending the marked tags to a patient for viewing on a patient display (e.g., patient dashboard, mobile app, or the like) (FIG. 11). The database schema illustrated in FIGS. 5 and 6 can be utilized in these embodiments.

The additional (optional) feature of tracking completion in accordance with the invention can be implemented by various systems and methods. For example, when messages are sent to the patient, or viewed by the patient, this is noted by the tracking module. As previously described, the message can be sent via email or sms, or the message may be displayed via a patient dashboard, mobile app, or other system. The tracking module may also monitor or record when a patient completes a recommendation. This can be determined by, for example:
1. the patient books an appointment on an aggregator scheduling system that matches the ProcedureId of the tag;
2. the patient updates check-in data and indicates that a procedure (associated with the ProcedureId of the tag) has been performed;
3. the patient completes the recommended procedure offline and reports to the tracker any number of ways, including:
   a. a link in the email message;
   b. by replying to the email message;
   c. by clicking a button on the patient dashboard or a mobile application;
4. a healthcare or insurance provider reports to the tracker (e.g., aggregator) that the patient completed the procedure, either director or indirectly.

The aggregator can then provide multi-dimensional reporting by comparing this tracking data with patient data (check-in data, demographics, appointment history and/or other information the aggregator may have).

The methods of FIGS. 9-11 will now be described in detail.

FIG. 9 illustrates a method 200 with a first step 201 of selecting a patient. In next step 202, an empty tag set is provided for the patient. In next step 203, the process pulls a list of providers in the order of provider priority; the process may optionally limit the list to, for example, a list of preferred providers. In next step 204, for each provider on the provider list, it is determined whether the patient is a match for this provider. If yes, in step 205 the matched provider's tags are retrieved, ordered by the provider's tag priority, and added to the patient's tag set, and the process continues with the next provider on the list (step 206). After all the providers are processed, the duplicate tags from the tag set are removed, keeping each tag with the highest priority (step 207). In next step 208, for each tag on the tag list, it is determined whether the tag is applicable to the patient (e.g., based on patient parameters). If not, in step 209 the tag is removed from the tag list. In next step 210, it is determined if there is another tag on the list. If yes, it returns to step 208, if not, it returns the applicable tag list for the patient at step at 211, and the process ends.

FIG. 10 illustrates a process 300 in which a patient is selected (step 301). In next step 302, the process pulls a list of applicable tags for this patient. In next step 303, for each tag on the tag list, it is determined whether the tag is outstanding for this patient (i.e., not completed). If it is outstanding, then the process continues to the next tag on the list 305. If the tag is not outstanding, it is removed from the tag list (step 304), and the process proceeds through the tag list (step 305). The result is a list of applicable and outstanding tags. In next step 306, it is determined whether each outstanding tag meets the message sending rules. If not, that tag is removed from the outstanding tag list (step 307), and the next tag is processed (step 308). After all outstanding tags have been processed, the process continues to step 309 where messages are generated for the remaining tags on the list. Optionally, only the highest priority tag can be used to generate a message. As a further alternative, a single message may be sent concerning multiple tags (recommendations). In the next step 310, the messages are sent to the patient. In the next step 311, it is determined whether tracking is desired. If yes, in step 312 the process tracks patient completion, if not, the process ends.

FIG. 11 illustrates a process 400. In the first step 401, the patient is selected. In a next step 402, a list of applicable tags is pulled for the patient. In the next step 403, for each tag in the tag list, it is determined whether the tag is outstanding for the patient. If yes, in step 404 the tag is marked outstanding and the process proceeds to the next step on the list (step 405). If a tag is not outstanding, the tag is marked completed (step 412) and the process proceeds to the next tag on the list. After all tags are processed, in the next step 406 the marked tags are sent to a patient display. Next, if tracking is desired (step 407) then patient completion of the recommendations is tracked (step 408). Next, it is determined if a patient has completed a marked tag (step 409). If yes, the tag is marked completed (step 410). If not, the process returns to tracking patient completion. When a tag is updated (marked completed), it is then sent to the patient display (step 411) and the process ends.

The previously described methods may be implemented in a suitable computing environment, e.g., in the context of computer-executable instructions that may run on one or more computers. In, for example, a distributed computing environment, certain tasks are performed by remote processing devices that are linked through a communications network, and program modules may be located in both local and remote memory storage devices. The communications network may include a global area network, e.g., the Internet, a local area network, a wide area network or other computer network. It will be appreciated that the network connections shown herein are exemplary and other means of establishing communications between the computers may be used.

A computer may include a processing unit, a system memory, and system bus, wherein the system bus couples the system components including, but not limited to, the system memory and the processing unit. A computer may further include disk drives and interfaces to external components. A variety of computer-readable media can be accessed by the computer and includes both volatile and nonvolatile media, and removable and nonremovable media. A computer may include various user interface devices, including a display screen, touch screen, keyboard, or mouse.

Referring now to FIG. 12, there is illustrated a general system configuration for communications between patient(s) and the aggregator, and between practice and/or insurance group(s) and the aggregator. In one embodiment, the system 1000 includes an aggregator's platform 1002 that hosts at least a data management tool, here a web application server 1004. The server 1004 provides a common layer to underlying services that include a database server 1006, a mass storage 1010, and an interface 1008, to a high-speed data connection 1012 (e.g., T1, DS3), to accommodate processing, storage and/or communications with remote locations and/or users (e.g., patients, practice groups) from virtually any accessible network node. Further, the platform 1002 can include a processor 1014 suitable for XML (extensible Mark-up Language), XSLT (XML Stylesheet Language, Transformations), and SSL (Secure Sockets Layer) processing. The processor 1014 can also access web based services utilizing SOAP (Simple Object Access Protocol). There is a high speed connection 1016 (e.g., broadband) that interfaces to the processor layer 1014 for multiple communication exchanges with remote users accessible on a global communications network 1030 (e.g., Internet). The remote users can access the platform 1002 via an SSL connection 1018 using portable wired/wireless devices 1020, or by way of the associated browsers 1022, or other applications.

FIG. 13 is a schematic block diagram of system 150 illustrating a data staging area for compiling healthcare information from a plurality of healthcare information sources, e.g., 12, 112, 11, 111 of FIGS. 1A-1B, into a common format. The data staging area 152 receives healthcare data from a plurality of healthcare information sources 151 as raw data. Data staging area 152 receives raw data (data loaders 153) and reformats the raw healthcare data into data structures 154 for subsequent use in the rules engine 155. This is one example by which the patient data and healthcare data of FIGS. 1A and 1B, which originate from a plurality of different sources and are received in a plurality of different incompatible formats, can be translated into structured data for populating the respective databases and determining the logic (rules) for generating the recommended healthcare actions.

What has been described above includes examples of the present invention. It is, of course, not possible to describe every conceivable combination of components or methodologies for purposes of describing the present invention, but one of the ordinary skill in the art will recognize that further combinations and permutations of the present invention are possible. Accordingly, the present invention is intended to embrace all such alternations, modifications and variations that fall within the present disclosure and/or claims.

1. A computer-implemented method comprising:
storing electronic patient data for a plurality of patients in a data storage unit;
analyzing in a computer the patient data by applying process logic to the patient data of a particular patient to generate one or more recommended healthcare actions for the patient;
generating by a computer and transmitting to the patient an electronic message including the recommended actions;
wherein the process logic is based on one or more of:
best medical practices;
evidence based rules;
clinical rules;
healthcare provider preferences;
policies and payor rules;
financial coverage;
consumer preferences; and
aggregate population clinical data.

2. The method of claim 1, wherein the process logic filters based on one or more of patient specific filters, healthcare provider specific filters, patient's eligibility for insured healthcare services or benefits, healthcare spending accounts, and employer-operated benefit services associated with the recommended actions.

3. The method of claim 1, wherein the actions include one or more of:
becoming informed about the nature of a healthcare issue;
consulting a healthcare provider to evaluate a health issue; and
providing an interactive user interface for the patient to monitor his/her healthcare.

4. The method of claim 1, wherein the message comprises one or more of email, text, mobile application, webpage or other electronic messaging system.

5. The method of claim 1, wherein the message includes an interactive link through which the patient selects or implements one or more of the recommended actions.

6. The method of claim 1, wherein the message includes as a recommended action booking an appointment for healthcare provider services and the message includes a link for implementing the recommended action.

7. The method claim 1, further including:
electronically tracking the patient responses to the recommended actions.

8. The method claim 7, wherein the tracking comprises monitoring healthcare provider appointments of the patients.

9. The method of claim 1, wherein the patient data includes one or more of check-in data, medical history, family history, demographic, symptom, insurance, clinical, health, wellness, preventive medicine, medication, and mental health.

10. A computer-implemented method comprising:
for a collection of stored patient profile information for a plurality of patients and a collection of tags, each tag comprising a recommended action for one or more patients;
for each tag of the collection, applying application logic that determines if a tag of the collection is applicable to a respective patient based on the patient's stored patient profile information and for one or more of the determined applicable tags;
transmitting a message to the respective patient concerning the applicable tags, the message including an interface for implementing the recommended actions;
following the transmitting, monitoring the respective patient for completion of recommended actions of the associated tags.

11. The method of claim 10, wherein the application logic includes determining if
the recommended action has not been fulfilled for the respective patient and transmitting messages for one or more tags that are both applicable and not fulfilled.

12. The method of claim 10, wherein the tags comprise one or more best practices for patient care.

13. The method of claim 10, wherein the tags comprise one or more of scheduling a healthcare appointment and supplying patient information.

14. The method of claim 10, including applying segment logic that selects among different variants of a message for an associated tag based on the patient profile information for the respective patient and the method includes comparing the patient completion for the different message variants.

15. The method of claim 10, wherein one or more of the application logic and
segment logic filters based on one or more of the healthcare provider and insurance provider of the respective patient.

16. A computer-implemented method comprising:
collecting electronic rules data from multiple healthcare or insurance providers, the data including recommended healthcare actions based on patient parameters;
generating by a computer relative priority values for the collected rules data and storing the collected rules data and priority values in a data storage unit;
on a periodic basis, applying process logic and the stored rules data and priority values to individual electronic patient profile information for a plurality of patients to:
identify a match of individual patient to the rules data based on the associated patient parameters and patient profile information;
selecting by the computer one or more of the matches based on the priority values of the associated rules data; and
generating by the computer, an electronic message including one or more recommended healthcare actions based on the selected matches.

17. The method of claim 16, wherein the method further comprises:
electronically tracking the patient responses to the recommended actions.

18. The method of claim 17, wherein the method further includes:
comparing the tracking responses of multiple patients.

19. The method of claim 16, wherein the message includes an interactive link through which the patient selects or implements the recommended action.

20. A data processing system for recommending patient healthcare actions, the system comprising:
a communications controller,
a data storage unit having stored therein:
patient profile information for a plurality of patients;
a plurality of tags, each tag comprising a recommendation for patient healthcare action and rules, the rules including rules determining whether a recommendation for a patient is applicable and unfulfilled;
a computer, coupled to said data storage and to said communications controller to:
for a patient, apply a set of one or more tags to the patient profile information,
for an applied tag that is applicable and unfulfilled, generate an electronic message for the patient with the recommended healthcare action,
transmit the electronic message to the patient via the controller.

21. The system of claim 20, wherein the stored data further includes a limit on the number of tags sent to a patient over a given time period, and the controller transmits no more than the designated number of electronic messages to the patient in the designated time period.

22. The system of claim 20, wherein the data storage unit includes different tag sets for different rules providers, the different rules providers comprising healthcare providers, insurance providers, and other rule providers associated with a patient, and wherein the patient profile information includes an identification of the patient's associated providers, and the computer is configured to select from the tag sets of the associated providers for the patient.

23. The system of claim 22, wherein the stored data includes a priority for each rules provider and the computer is configured to apply the rules provider priority in determining a priority in which to transmit electronic messages to the patient.

24. The system of claim 20, wherein the stored data includes a tag priority and the computer is configured to apply the tag priority in determining an order and limit for transmitting electronic messages to the patient.

25. The system of claim 20, wherein the computer is further configured to track patient responses to the recommended actions.

26. The system of claim 25, wherein the computer is configured to compare the track responses.
